(19) United States
(12) Patent Application Publication
(10) Pub. No.: US 2025/0119784 A1
(43) Pub. Date: Apr. 10, 2025

(54) APPARATUSES AND METHODS FOR FACILITATING AN ACTIVE PATH INVENTORY VIA PATH SOURCING ALGORITHMS

(71) Applicant: Ciena Corporation, Hanover, MD (US)

(72) Inventor: John Wade Cherrington, Salt Spring Island (CA)

(73) Assignee: Ciena Corporation, Hanover, MD (US)

(21) Appl. No.: 18/482,980

(22) Filed: Oct. 9, 2023

(51) Int. Cl. H04W 28/02; H04L 45/24; H04L 45/30; H04W 40/34

(52) U.S. Cl. CPC H04W 28/0236; H04L 45/24; H04L 45/30; H04W 40/34

(57) ABSTRACT

Aspects of the subject disclosure may include, for example, obtaining a representation of a communication network or system, and processing the representation to identify a first subset of paths included in a plurality of paths for each class of a plurality of classes and for at least one pair of a source node and a destination node included in the representation. The first subset of paths may be less than an entirety of the plurality of paths. Other embodiments are disclosed.

### FIELD OF THE DISCLOSURE

The subject disclosure relates to apparatuses and methods for facilitating an active path inventory via path sourcing algorithms.

### BACKGROUND

As the world increasingly becomes connected via vast communication networks and systems and via various types of communication devices, additional opportunities are generated to provision communication services. The provisioning of communication services is accompanied by a host of challenges, particularly in view of the increasing demands of data-intensive applications and a scarcity of resources that are available. In this respect, network operators and service providers seek out ways to ensure that networks and systems are reliable and resilient in the face of dynamic circumstances, conditions, and events (in order to ensure high levels of quality of service (Qos) or quality of experience (QoE)), while at the same time attempting to keep resource counts low (thereby enhancing efficiency of network/system operations).

There are several algorithms and techniques that are available (such as, for example, Dijkstra, Floyd-Warshall, Yen's k-shortest path) to characterize paths associated with a network or system. These algorithms/techniques tend to view an analysis or identification of a path in isolation, which is to say they tend to be focused on the identification of a path between a source and a destination (hereinafter referred to as “s-d”) of a communication transaction (e.g., a data transaction), assuming that all potential paths are operable or valid. However, as set forth above, dynamic circumstances, conditions, and events may alter parameters associated with the pool of operable/valid paths. For example, a path that is operable/valid at a first point in time may undergo degradation (e.g., may become inoperable/invalid) at a second point in time. Operations pertaining to network/system reliability and resiliency may necessitate rapid recovery or alterations in the face of such degradation. Furthermore, network/system operations may necessitate enhancements in the efficiency of analyses/identifications of paths for multiple pairs of s-d endpoints (as opposed to an s-d pair of endpoints taken individually or in isolation), as rarely is a network or system engineer concerned with only a single pair of s-d endpoints. Moreover, an alteration of a path between a pair of s-d endpoints may have a ripple effect/impact on other paths between other s-d endpoints; this effect/impact needs to be understood and accounted for if QoS or QoE is to be maintained or enhanced across a pool/base of users/subscribers.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a graph of a network or system in accordance with various aspects described herein.

FIG. 2 is a block diagram illustrating an exemplary, non-limiting embodiment of the graph of FIG. 1, subject to a modification in accordance with various aspects described herein.

FIG. 3 depicts a flowchart of an illustrative embodiment of a method in accordance with various aspects described herein.

FIG. 4 is a block diagram of an example, non-limiting embodiment of a computing environment in accordance with various aspects described herein.

### DETAILED DESCRIPTION

The subject disclosure describes, among other things, illustrative embodiments for analyzing an impact that a degradation of a network or system link or node forming part of a path has on a resiliency or reliability of a provisioning of a communication service. Other embodiments are described in the subject disclosure.

One or more aspects of the subject disclosure include, in whole or in part, obtaining a representation (e.g., a baseline representation) of a communication network or system, and processing the representation to identify a first subset of paths included in a plurality of paths for each class (e.g., k-cut class) of a plurality of classes (e.g., a plurality of k-cut classes) and for at least one pair of a source node and a destination node included in the representation. The first subset of paths may be less than an entirety of the plurality of paths.

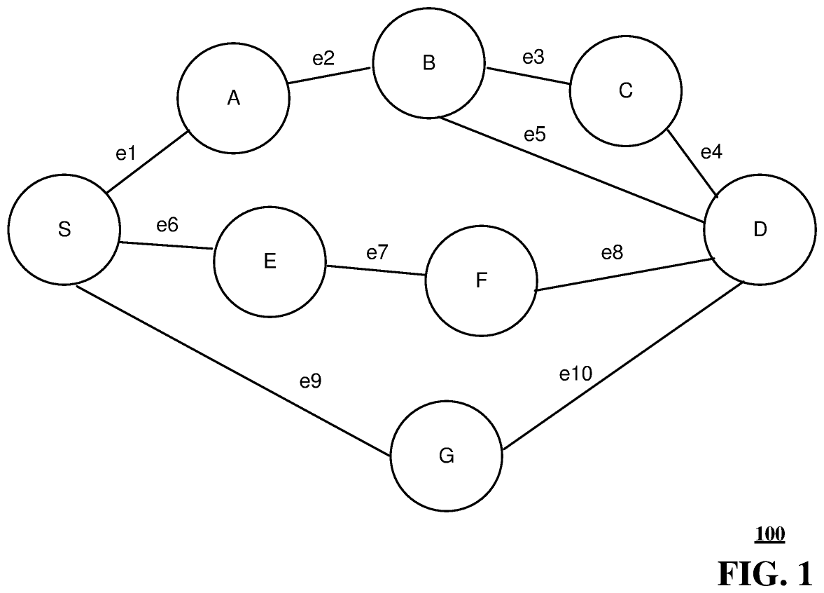

By way of introduction, aspects of this disclosure may be applied in respect of a communication network or system and may be used to identify paths between a source and destination pair (e.g., an s-d pair). To demonstrate via an example, reference may now be made to FIG. 1, which depicts a graph 100 of a network or system. The graph 100 may include a number of nodes, such as nodes labeled A, B, C, D, E, F, G, and S, and a number of edges, such as edges labeled e1, e2, e3, e4, e5, e6, e7, e8, e9, and e10. The edges e1 through e10 may connect, or communicatively couple, the nodes A, B, C, D, E, F, G, and S to one another in the manner shown in FIG. 1. To demonstrate, the edge e1 may couple the node S and the node A to one another. Communications or signaling involving an edge (analogously, a link) may be unidirectional or bidirectional in nature.

By virtue of the arrangement of the graph 100 shown in FIG. 1, there may be four paths between the node S and the node D (in the exemplary embodiment of FIG. 1, the nodes S and D may form an s-d pair as described above, such as for example in relation to a data transaction associated with a communication service). For example, the first path may include nodes A, B, and C, the second path may include nodes A and B, the third path may include nodes E and F, and the fourth path may include node G.

It should be kept in mind that in many practical applications involving the graph 100 (or a counterpart thereto) that there may be constraints (e.g., timing or routing constraints) that may dictate whether, and to what extent, a given path is used involving an s-d pair. For example, it may be the case that, despite the fact that the fourth path (involving the node G) is the shortest path (e.g., involves the lowest number of hops in terms of length or distance) between the node S and the node D that a first user of (e.g., a first subscriber to) the network/system associated with the graph 100 has mandated that the node G not be used (perhaps the node G is prone to security breaches that the first user would prefer to avoid). In another example, a second user may require that the first path (involving the nodes A, B, and C) and the second path (involving the nodes A and B) both be utilized due to the various features that may be available at the nodes A, B, and C, in order to allocate a portion of a load (e.g., a processing load) to the node C, etc. In general, various types of criteria, specifications, or requirements may be defined by a network or system operator, a user of a network or system (e.g., a subscriber), or any combination thereof, that may serve as constraints.

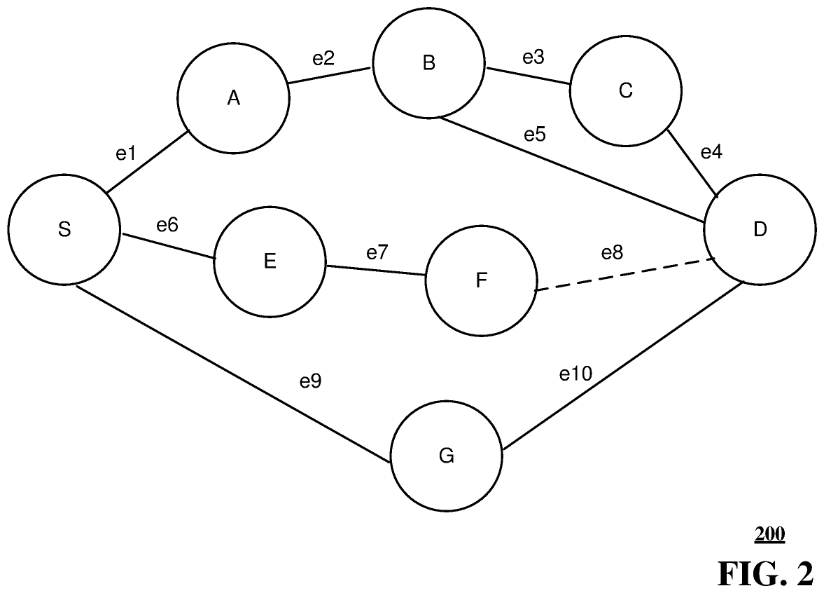

The graph 100 may represent a portion of a network or system, which is to say that in many practical applications of this disclosure there may be hundreds or even thousands of nodes, edges, paths, etc. Furthermore, the graph 100 may be representative of a (portion of a) network or system at a given point in time, which is to say that the graph 100 (or a counterpart thereto) may be modified or adapted based on an occurrence of one or more events, conditions, circumstances, etc. To demonstrate, if the graph 100 is representative of a fiber network, and the edges e1 through e10 are representative of respective fiber links, a loss of the edge e8 (due to, e.g., a cut in the edge e8) may result in a loss of a path between the node S and the node D involving the nodes E and F. This loss of the edge e8 is shown in respect of the system 200 of FIG. 2 via the dashed line associated with the edge e8. Of course, functionality associated with multiple edges may be lost simultaneously/concurrently; e.g., inoperability may be present in respect of, or associated with, multiple edges. The loss of multiple edges (or, analogously, nodes) is considered in further detail below.

Aspects of this disclosure may build upon one or more techniques or algorithms (e.g., Yen's k-shortest path), whereby the shortest path in an initial/baseline representation of a network/system may be identified, and thereafter the shortest path may be identified in respect of k-cut classes where edges have been removed from the baseline (perhaps due to a cut, or other defect, in the manner set forth above). In this respect, Yen's algorithm may be conceptualized as an ordered path enumeration algorithm with different stopping criteria. The most common (and originally definitional) stopping criteria may be to stop after reaching k-shortest paths (noting that if at any point the last path has been found the algorithm may terminate at that point). A second stop-out condition used less often for its potential run-time implications is to run/execute with no outer limit, i.e., run to exhaustion and/or until a timeout condition is met.

Assuming that a single path is chosen as a baseline, k-cut style optimization may be performed. As part of this optimization, Yen's algorithm may be used to enumerate the paths as if it were “open loop” in performing an enumeration. As each path is generated, unless the path is an exact match to the baseline the path may be in one or more k-cut classes of the baseline based on the number of edges it is lacking. A map or table may be maintained from n-cut classes to which paths are in the class, where an index into the map/table may correspond to the tuple of edges (e.g., <e1>, <e1, e2>, . . . etc.) and the values of the map/table may correspond to a growing, ordered list of paths that are members of the class. As the enumeration may be in length order, the n-cut classes may be populated in order of shortest-to-longest as well. For each k-cut class, minimum and maximum targets may be defined. A minimum target may correspond to a minimum number of paths between an s-d pair (e.g., to ensure reliability/resiliency), whereas a maximum target may cap or limit the number of paths for the sake of processing/execution speed (in this regard, the maximum target may also, or alternatively, correspond to a condition of exhaustion, where there are no additional paths available in the pool of paths). The output of the algorithm may include a “master” list of all shortest paths that were found over the run, along with the map/table that indicates for each k-cut relative to the baseline the paths that are in the k-cut class.

Aspects of the algorithm described above may be extended to multiple paths. For example, aspects of the algorithm may be used to optimize a network or system involving different or multiple layers. From a provisioning perspective, some edges or layers may be (at least initially) excluded based on a finding that solutions are often well-approximated by optimizing over a small number (relative to potential total possible) number of paths. There may also be an inherent total length or total across-edge property constraint in play, such as from latency, viability/OSNR, hops, or total bandwidth used, etc. Further, it is noted that k-cut considerations may be more nuanced when a communication service is supported by weighted multipaths. For the part of multipaths that share common edges, a loss of an edge may be equivalent to a loss of a single path, extended to all associated paths that may lose continuity. When the loss of one path, due to a loss of an edge, could be absorbed by another path as part of the analysis, it may be possible to exclude the tracking of that edge.

As set forth above, in some embodiments a maximum target may correspond to a timeout condition to reduce or cap processing time relative to a threshold. For example, in some instances it may be the case that: (a) the potential paths are not exhausted, (b) some cut classes have been missed, and (c) a timeout has occurred. In such instances, on first exit (with missed minimum targets), optimization may be initiated relative to the initial targets that have been reached/identified for the k-cut. As the optimization is occurring, follow-up queries may be performed (that exclude the edges in sub-target class) to determine if there are additional paths/targets that have been missed. Any such paths/targets that are identified as part of the follow-up queries may be allocated for optimization, where they can be executed or acted upon following the execution/optimization performed upon the initial targets.

Aspects of the foregoing, inclusive of aspects of Yen's and Dijkstra's algorithms/techniques, may be extended to consider multiple s-d pairs. For example, a pool of parallel workers, controllers, processing systems, etc. (hereinafter collectively or individually referred to as a worker), may each be running a baseline version of Yen's algorithm (as potentially subject to modifications set forth above) while sharing a key-value cache of known paths on an original/initial path with specific edges that are excluded. The keys of the key-value cache may correspond to s-d pairs with a finite list of excluded edges (the edges that are allowed may be those from an original graph G). The values of the key-value cache may correspond to the shortest path for a given s-d pair on the original graph with the given excluded edges defined by the key removed. In some embodiments, Dijkstra techniques may be applied to filter or remove the excluded edges.

Each worker may be allocated a portion of the vertex space. Workers may be assigned new vertices as they become available. A baseline algorithm may be used, whereby the baseline algorithm may take the form of 1−N k-shortest paths in which the worker is trying to find k-shortest paths to N destinations from a given source. In particular, an initial/baseline Dijkstra call may be transformed into a 1−N call, which may be more efficient in establishing the respective shortest path from the source to each of the N destinations than executing N separate/repeated Dijkstra calls. Aspects of Yen's algorithm may then be applied to examine the shortest paths identified to that point, may select the last/longest path that was previously added, and may form a sub-path corresponding to a root and a spur at different points along that last/longest path. The root and spur may be used to establish excluded edges, setting up subsequent calls from the spur to each next sink/destination, with specific excluded edges being passed-in depending on the particular sink. The calls may be de-duplicated across the different sinks and across different spur points per sink. Following de-duplication, any (e.g., all) required spur calls may be made. For example, these spur calls may be Dijkstra calls with specific s-d destinations and one or more subsets of excluded edges. As the same routing query may cross multiple workers, a shared cache/library may be utilized and consulted. If there is a hit or match in the shared cache/library, results may be pulled or obtained from the cache/library, as opposed to executing another Dijkstra call.

By virtue of the foregoing, and in particular the treatment of a path as being formed from a root and spur(s) at various parts/points along the path, and the use of a cache/library to store partial/temporary results, processing time involving multiple s-d pairs may be substantially reduced. As one of skill in the art will appreciate based on a review of this disclosure, such a reduction in processing time may be achieved based on a recognition that results from prior processing tasks may be reused, thereby promoting efficiency gains.

Further gains or enhancements in efficiency may be obtained based on a recognition that workers may be loaded with tasks/vertices in different orders or sequences, and no two orders/sequences are necessarily equal. For example, and all other conditions being assumed equal, given a sub-pool of vertices that are close to one another on a graph, the sub-pool may be more likely to result in overlapping sub-calls relative to a utilization of calls involving random members of the pool selected at large. As a result, the rate of cache/library hits may be greater utilizing the sub-pool relative to the random members of the pool at large. Thus, graph-locality aware loading of the workers may be employed to enhance (e.g., maximize) efficiency. Still further, vertices that are tied/coupled to edges for which there is a highest/higher edge betweenness centrality (EBC) value may initially be selected for allocation to the workers. Such edges may be more likely to participate in any given short path (all other conditions being assumed equal), and by extension, may be involved in sub-paths of larger paths. Under this strategy/approach, a network/system with a core-edge structure or arrangement may have its core-crossing paths known to/established in the cache/library first, and hence when edge-to-edge paths are discovered the core-crossing sub-paths that may arise in the spur calls utilizing Yen's techniques may already be present in cache/library.

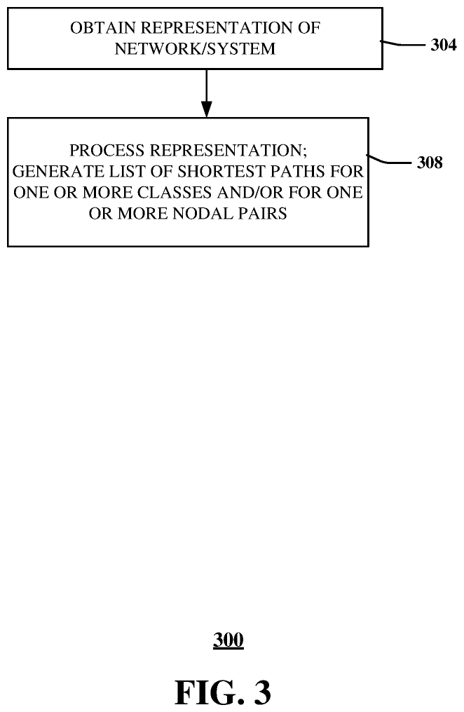

Referring to FIG. 3, a flowchart of an illustrative embodiment of a method 300 in accordance with various aspects described herein is shown. The method 300 may be implemented (e.g., executed), in whole or in part, in conjunction with one or more systems, networks, devices, or components, such as for example the systems, networks, devices, and components described herein. The method 300 may be implemented to realize functionality associated with one or more algorithms or techniques, such as the algorithms/techniques set forth above. The method 300 is described below in relation to the blocks shown in FIG. 3. The blocks may be associated with operations that may be implemented via one or more instructions (e.g., executable instructions). For example, the instructions may be executed by a processing system that may include one or more processors.

In block 304, a representation of a network or system may be obtained. For example, the representation of the network or system may take the form of, or include, a graph-see, e.g., graphs 100 and 200 of FIGS. 1-2.

In block 308, the representation of the network/system obtained as part of block 304 may be processed. The processing of block 308 may utilize one or more algorithms or techniques, such as the algorithms and techniques described above. The processing of block 308 may occur across/at one more portions/parts of the network/system. For example, the processing of block 308 may occur in respect of a single s-d pair and/or may be applied in respect of multiple s-d pairs.

The processing of block 308 may result in a determination or identification of (a list of) shortest paths for one or more classes (e.g., one or more k-cut classes), operating under an assumption that the shortest paths may be of primary interest to a network operator or service provider in respect of a provisioning of a communication service with the lowest latency, fewest number of hops, greatest reliability/resiliency, etc. The foregoing may be generalized to focus on any other parameter(s) that may impact or effect communications or signaling in a network or system, such as for example generating/identifying a subset of paths that: enhances (e.g., maximizes) signal to noise plus interference ratio (SINR), reduces (e.g., minimizes) an amount of transmission power that is needed, enhances (e.g., maximizes) throughput, reduces (e.g., minimizes) modulation/demodulation complexity, etc., or any combination thereof.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As demonstrated herein, aspects of this disclosure may be implemented in respect of a multitude of practical applications involving devices or components of networks and systems. For example, aspects of this disclosure may be used to analyze the reliability or resiliency of an existing network or system in the face of changes to parameters, paths, etc., associated with the network/system. Furthermore, aspects of this disclosure may be utilized as part of practical applications to identify potential weaknesses or vulnerabilities in a network or system, allowing modifications potentially to be made before such weaknesses/vulnerabilities manifest themselves as part of degraded network/system performance. In this respect, aspects of this disclosure may be utilized as part of network or system planning operations.

The various aspects of this disclosure may represent substantial improvements to technology in that the various aspects enable updates or modifications to paths associated with s-d pairs in a way that represents small (e.g., minimal) marginal cost when small/minor changes are made or occur. Moreover, the various aspects of this disclosure enable an identification of, or update to, paths associated with s-d pairs with greater efficiency than a computation of the single shortest path for all pairs.

In brief, as demonstrated herein, and as one of skill in the art will appreciate based on a review of the disclosure, the various aspects of this disclosure are not directed to abstract ideas. To the contrary, the various aspects of this disclosure are directed to, and encompass, significantly more than any abstract idea standing alone.

Aspects of this disclosure may be implemented or practiced as respective portions that may, in the aggregate, contribute to realizing a particular or specified functionality. In this regard, the various operations and processes may be staged or sequenced with respect to one another in order to realize or achieve such functionality in a consistent or coherent manner.

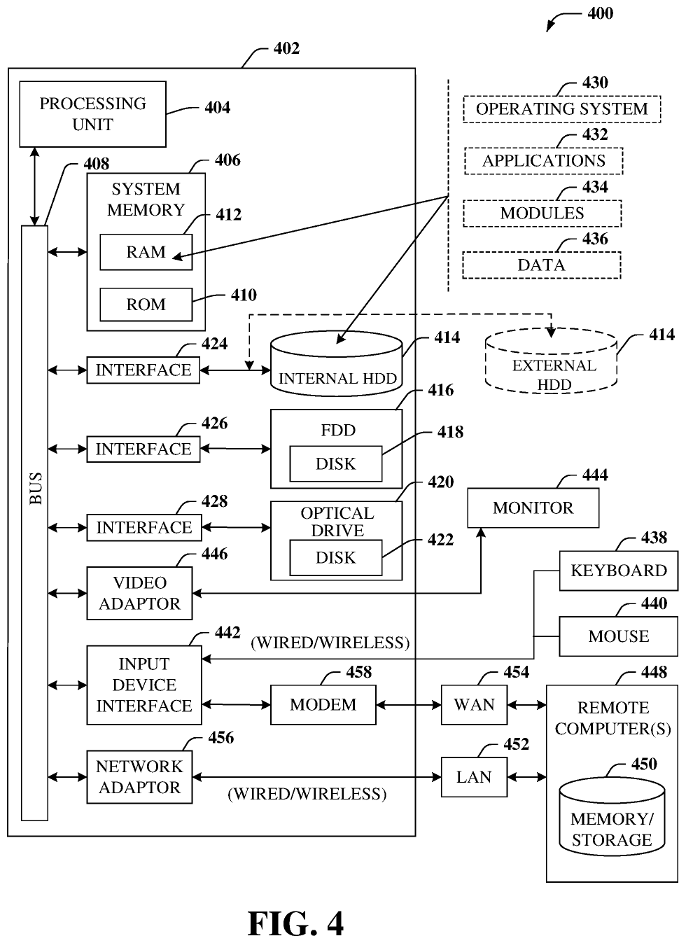

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, the computing environment 400 can facilitate, in whole or in part, obtaining a representation (e.g., a baseline representation) of a communication network or system, and processing the representation to identify a first subset of paths included in a plurality of paths for each class (e.g., k-cut class) of a plurality of classes (e.g., a plurality of k-cut classes) and for at least one pair of a source node and a destination node included in the representation. The first subset of paths may be less than an entirety of the plurality of paths.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. Instances of elements or functions may be distinguished or differentiated from one another via a use of the terms “first”, “second”, “third”, and the like. The instances may correspond to a same or similar type, or may correspond to different types.

What is claimed is:

1. A non-transitory machine-readable medium, comprising executable instructions that, when executed by a processing system including a processor, facilitate performance of operations, the operations comprising:
obtaining a representation of a communication network; and
processing the representation to identify a first subset of paths included in a plurality of paths for each class of a plurality of classes and for at least one pair of a source node and a destination node included in the representation, wherein the first subset of paths is less than an entirety of the plurality of paths.

2. The non-transitory machine-readable medium of claim 1, wherein each path of the first subset of paths is shorter than any other path that is included in a second subset of paths of the plurality of paths.

3. The non-transitory machine-readable medium of claim 2, wherein the processing results in an ordering of the first subset of paths in accordance with the respective lengths of the paths.

4. The non-transitory machine-readable medium of claim 1, wherein the communication network includes a fiber network.

5. The non-transitory machine-readable medium of claim 4, wherein each of the plurality of classes corresponds to a respective number of links that are subject to degradation in the fiber network.

6. The non-transitory machine-readable medium of claim 5, wherein the degradation corresponds to a loss of operability.

7. The non-transitory machine-readable medium of claim 1, wherein the at least one pair of the source node and the destination node includes a plurality of pairs of source nodes and destination nodes.

8. The non-transitory machine-readable medium of claim 1, wherein the representation includes a graph.

9. The non-transitory machine-readable medium of claim 8, wherein the processing of the representation includes first processing and second processing that occurs subsequent to the first processing, and wherein the operations further comprise:
selecting first portions of the representation for the first processing based on the first portions having a higher edge betweenness centrality (EBC) value in respect of edges of the graph relative to second portions of the representation.

10. The non-transitory machine-readable medium of claim 9, wherein the second portions of the representation are associated with the second processing, and wherein the second processing leverages an output of the first processing to reduce an execution time of the processing of the representation.

11. The non-transitory machine-readable medium of claim 10, wherein the first processing results in the output being stored to a cache, and wherein the second processing leverages the output from the cache.

12. The non-transitory machine-readable medium of claim 1, wherein the processing is subject to: a first constraint that requires a utilization of a first node that is between the source node and the destination node, a second constraint that requires an avoidance of a second node that is between the source node and the destination node, or a combination thereof.

13. The non-transitory machine-readable medium of claim 1, wherein the processing is subject to a first constraint that requires at least a first number of paths to be included in the plurality of paths for each class of the plurality of the classes.

14. The non-transitory machine-readable medium of claim 13, wherein the processing is subject to a second constraint that requires less than a second number of paths to be included in the plurality of paths for each class of the plurality of classes.

15. The non-transitory machine-readable medium of claim 14, wherein the processing is subject to a third constraint that requires that the processing be completed in an amount of time that is less than a threshold.

16. The non-transitory machine-readable medium of claim 1, wherein during the processing of the representation a timeout is reached in respect of a given class included in the plurality of classes, wherein the processing of the representation includes first processing performed in respect of a first plurality of paths included in the first subset of paths for the given class and second processing performed in respect of a second plurality of paths included in the first subset of paths for the given class, the first plurality of paths being identified prior to the timeout being reached and the second plurality of paths being identified subsequent to the timeout being reached, the second plurality of paths being different from the first plurality of paths.

17. The non-transitory machine-readable medium of claim 1, wherein:
each path of the first subset of paths has a greater signal to noise plus interference ratio (SINR) relative to any other path that is included in a second subset of paths of the plurality of paths,
each path of the first subset of paths is associated with less transmission power relative to any other path that is included in the second subset of paths,
each path of the first subset of paths is associated with greater throughput relative to any other path that is included in the second subset of paths,
each path of the first subset of paths is associated with a lesser degree of modulation/demodulation complexity relative to any other path that is included in the second subset of paths,
or any combination thereof.

18. A method, comprising:
obtaining, by a processing system including a processor, a representation of a communication network; and
processing, by the processing system, the representation to identify a first subset of paths included in a plurality of paths for each class of a plurality of classes and for at least one pair of a source node and a destination node included in the representation, wherein the first subset of paths is less than an entirety of the plurality of paths.

19. The method of claim 18, wherein the at least one pair comprises a plurality of pairs.

20. The method of claim 18, wherein the communication network includes a fiber network, and wherein each path of the first subset of paths is shorter than any other path that is included in a second subset of paths of the plurality of paths.
